(19) United States
(12) Patent Application Publication
(10) Pub. No.: US 2001/0031392 A1
(43) Pub. Date: Oct. 18, 2001

(54) Mount frame for battery modules and method for mounting battery modules using the same

(75) Inventors: Yoshiaki Ogata, Aichi (JP); Shinji Hamada, Aichi (JP); Munehisa Ikoma, Aichi (JP)

Correspondence Address: MERCHANT & GOULD PC, P.O. BOX 2903, MINNEAPOLIS, MN, 55402-0903, US

(73) Assignee: Matsushita Electric Industrial Co., Ltd and Toyota Jidosha Kabushiki Kaisha

(21) Appl. No.: 09/829,241

(22) Filed: Apr. 9, 2001

(30) Foreign Application Priority Data
Apr. 12, 2000 (JP) 2000-110694

(51) Int. Cl. H01M 2/10

(52) U.S. Cl. 429/99; 429/100

(57) ABSTRACT

A mount frame of the present invention includes a frame in which a plurality of openings are formed. Battery modules can be inserted removably into a plurality of openings.

### BACKGROUND OF THE INVENTION

1. Field of the Invention

The present invention relates to a mount frame for battery modules, and a method for mounting battery modules using the same.

2. Description of the Related Art

A number of alkaline storage batteries such as a nickel-cadmium battery and a nickel-hydrogen battery are used as power sources for portable equipment such as a video tape recorder, a notebook computer, and a mobile phone. These alkaline storage batteries have a battery capacity of about 0.5 Ah to about 3 Ah.

However, in recent years, a high energy density alkaline storage battery usable over a wide temperature range is being developed for use as a power source for an electric automobile and a hybrid automobile. In the case where an alkaline storage battery is used for such a purpose, a battery capacity of about several Ah to about 100 Ah is required.

Such an alkaline storage battery generally is used in such a manner that a plurality of modules are integrated by binding bands. FIG. 7 shows a conventional method for mounting modules using binding bands. As shown in FIG. 7, according to a conventional mounting method, a plurality of rectangular modules 1 are stacked on top of each other, and end plates 2 are disposed at both ends of the layered structure. Then, the end plates 2 are bound by the binding bands 3 to fix the modules 1.

However, according to the above-mentioned mounting method using binding bands, for example, in the case where the internal pressure of a module increases so as to expand a battery case, the other modules are compressed, as a result of which the modules cannot be bound stably. Furthermore, in the case of replacing one module, it is required to disassemble an entire battery pack. Thus, a module cannot be replaced easily. Furthermore, according to the above-mentioned conventional mounting method, it is difficult to freely change the height of the battery pack, as it is determined by that of the modules; therefore, a degree of freedom for mounting the battery pack onto an electric automobile or a hybrid automobile is small.

### SUMMARY OF THE INVENTION

Therefore, with the foregoing in mind, it is an object of the present invention to provide a mount frame for battery modules capable of binding a plurality of battery modules stably and allowing a battery module to be replaced easily, and a method for mounting battery modules using the same.

In order to achieve the above-mentioned object, the mount frame for battery modules of the present invention is used for fixing a plurality of rectangular battery modules, and includes a frame having a plurality of openings into which the battery modules are inserted removably. In the above-mentioned mount frame, even in the case where a difference in internal pressure is caused between the respective battery modules, the battery modules can be bound stably. Furthermore, the mount frame enables an individual battery module to be replaced easily.

It is preferable that the above-mentioned mount frame of the present invention further includes a stacking member for stacking a plurality of the frames on each other. Because of this construction, the height and output of a battery pack can be changed freely in accordance with a mounting place and a required output, so that a mount frame with high general versatility can be obtained.

It is preferable that the frame is made of metal, and the mount frame further includes a cooling member disposed on the frame. Because of this construction, a mount frame is obtained that has a high heat transfer property and suppresses effectively a temperature increase of the battery module.

It is preferable that the cooling member is at least one selected from the group consisting of a cooling fin and a coolant channel. Because of this construction, a temperature increase of the battery module can be suppressed easily and effectively.

It is preferable that the frame has unevenness on an inner surface of each opening, which is engaged with unevenness formed on a surface of each battery module. Because of this construction, a contact area between the battery module and the mount frame is increased, so that a temperature increase of the battery module can be suppressed easily and effectively.

It is preferable that the above-mentioned mount frame for battery modules further includes connecting terminals that are engaged with and electrically connected to electrode terminals of the battery modules upon inserting the battery modules into the openings. Because of this construction, electrical connection of the battery modules can be conducted easily.

Furthermore, the method for mounting battery modules of the present invention is for mounting a plurality of rectangular battery modules, wherein the battery modules are inserted into the openings of the above mount frame for battery modules, and thereafter, the mount frame is disposed so that electrode plates in the battery modules are placed in a substantially horizontal or vertical direction. Since, the mounting method of the present invention uses the mount frame of the present invention, an individual battery module can be replaced easily, and battery modules can be bound stably.

These and other advantages of the present invention will become apparent to those skilled in the art upon reading and understanding the following detailed description with reference to the accompanying figures.

### BRIEF DESCRIPTION OF THE DRAWINGS

FIG. 1A is a top view showing an exemplary battery module bound by using a mount frame of the present invention, and FIG. 1B is a side view showing an exemplary battery module bound by using a mount frame of the present invention.

FIG. 2 is a perspective view showing an exemplary mount frame for battery modules of the present invention.

FIGS. 3A to 3D illustrate an exemplary function of a connecting terminal of a battery module according to the present invention.

FIG. 4 is a perspective view showing another exemplary mount frame for battery modules of the present invention.

FIG. 5 is a perspective view showing still another exemplary mount frame for battery modules of the present invention.

FIG. 6 is a perspective view showing still another exemplary mount frame for battery modules of the present invention.

FIG. 7 is a perspective view showing an exemplary conventional method for mounting battery modules.

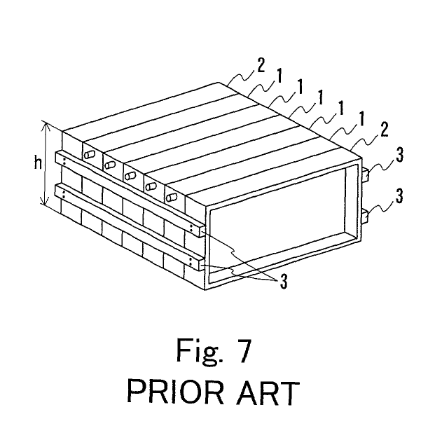

### DESCRIPTION OF THE PREFERRED EMBODIMENTS

Hereinafter, the present invention will be described by way of illustrative embodiments with reference to the drawings.

Embodiment 1

In Embodiment 1, an exemplary mount frame for battery modules of the present invention will be described.

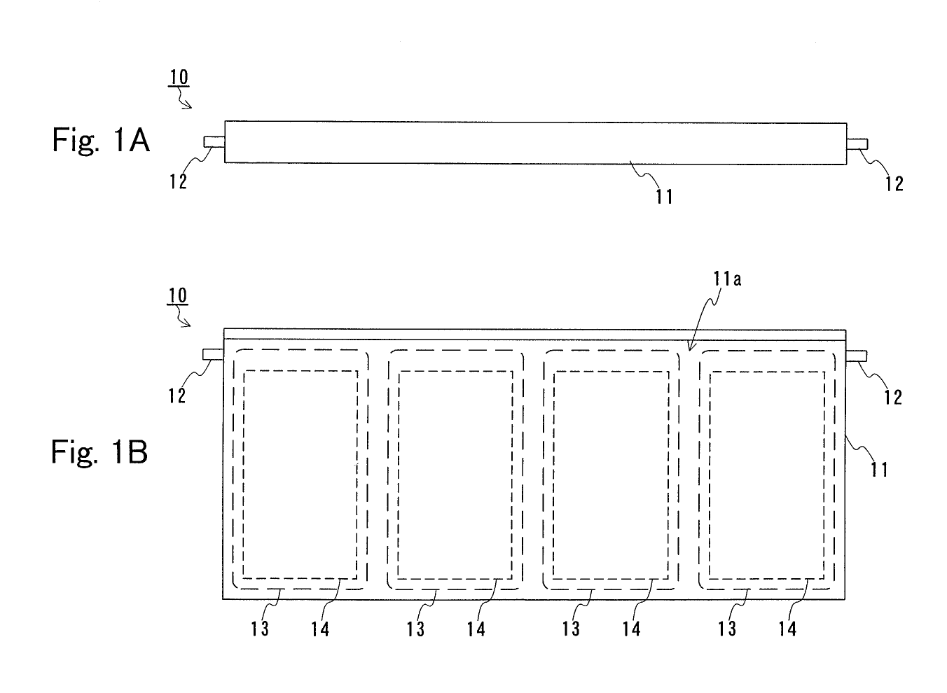

First, an example of a battery module composed of a nickel-hydrogen storage battery to be mounted onto the mount frame for battery modules of the present invention will be described. The capacity of the battery module is about several Ah to about 100 Ah, for example, 6.5 Ah. FIG. 1A is a top view of a battery module 10, and FIG. 1B is a side view thereof.

Referring to FIGS. 1A and 1B, the battery module 10 has a substantially rectangular shape. The battery module 10 includes a battery case 11 having a substantially rectangular shape and an electrode terminal 12. As schematically shown in FIG. 1B, a plurality of batteries 13 are arranged in the battery case 11. Electrode plates 14 stacked on each other alternately via separators are disposed so as to be substantially parallel to a side surface 11A that has a largest area among those of the battery case 11.

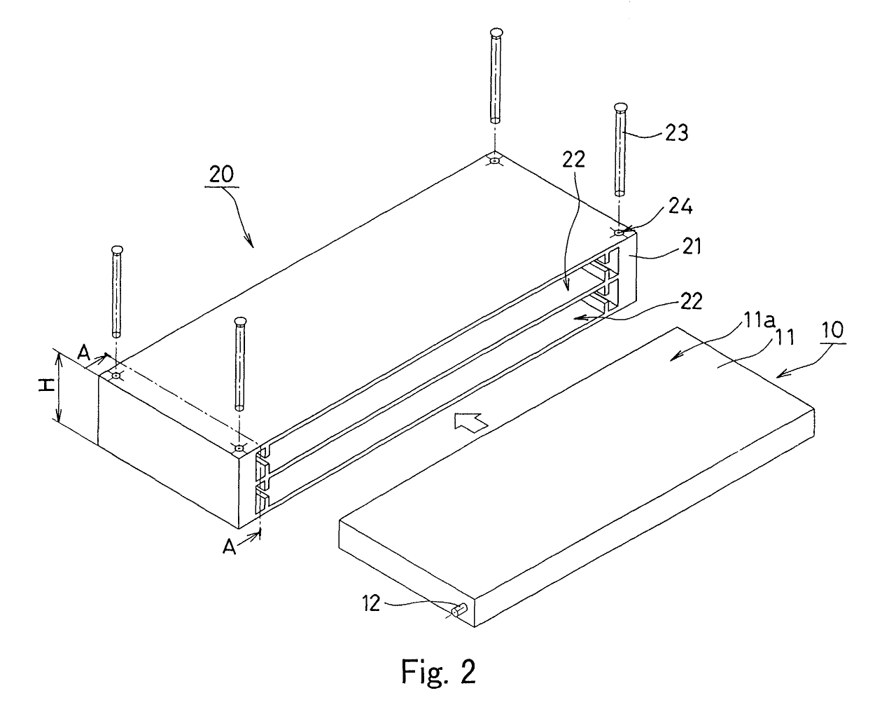

FIG. 2 is a perspective view of a mount frame 20 for mounting the above-mentioned rectangular battery modules 10. Referring to FIG. 2, the mount frame 20 includes a frame 21 in which a plurality of openings 22 are formed. The battery modules 10 are inserted into a plurality of openings 22 so as to be removable. Each opening 22 has a shape substantially equal to that of the battery module 10. The openings 22 are arranged so that a plurality of mounted battery modules 10 are disposed substantially in parallel to each other and aligned in a line. The openings 22 may have a shape allowing a plurality of battery modules 10 to be inserted in an integral manner.

The mount frame 20 may be disposed so that the batter modules 10 are placed in a vertical direction (i.e., the electrode plates of the battery modules 10 are placed in a vertical direction). Alternatively, the mount frame 20 may be disposed so that the battery modules 10 are placed in a horizontal direction (i.e., the electrode plates of the battery modules 10 are placed in a horizontal direction).

The frame 21 is provided with through-holes 24 for connection or fixing to another mount frame 20 with bolts 23. More specifically, the bolts 23 and the through-holes 24 function as a member for stacking a plurality of frames 21 on each other. The stacking member is not limited to a combination of the bolts 23 and the through-holes 24, and another stacking member may be provided. In the case where the mount frame 20 has a member for stacking the frames 21 on each other, the mount frame 20 is disposed so that the battery modules 10 are placed in a horizontal direction, and by changing the number of stacked frames 21 in accordance with the size of a space for mounting a battery pack, a height H (see FIG. 2) can be changed easily. Furthermore, by changing the number of stacked frames 21, a battery pack can be formed easily in accordance with a desired output. These are advantageous in that the battery pack can be used with a good on-vehicle property and flexibility as a power source for an electric automobile or a hybrid automobile. It is preferable that the frames 21 are stacked on each other so that the battery modules 10 are disposed in parallel to each other and aligned in a line.

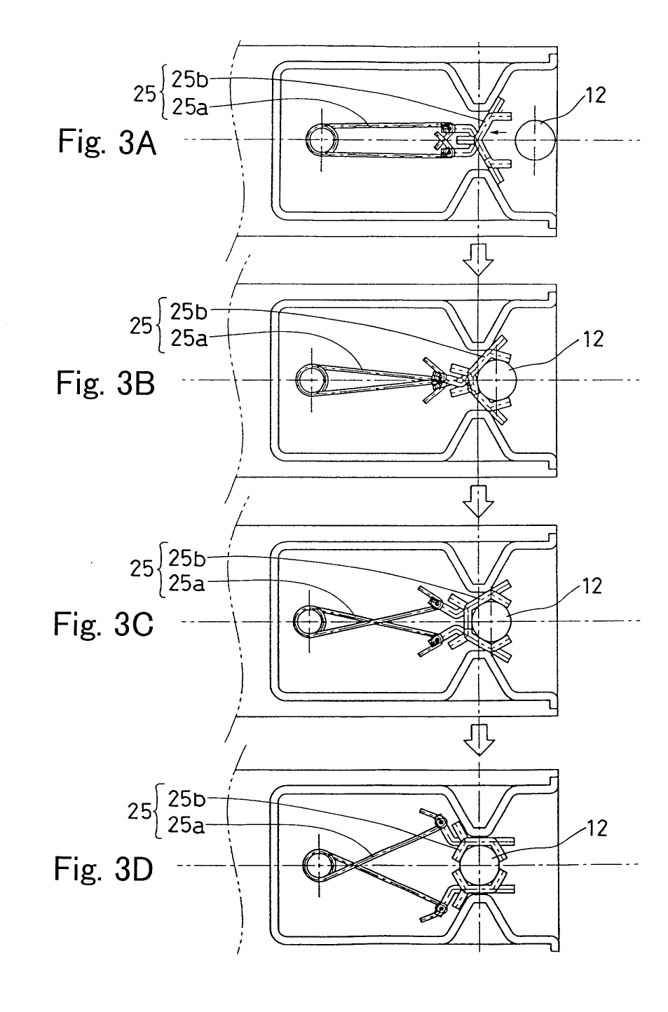

The mount frame 20 has connecting terminals 25 that are engaged with and electrically connected to the electrode terminals 12 of the battery modules 10 when the battery modules 10 are inserted into the openings 22. The function of the connecting terminal 25 will be described with reference to FIGS. 3A to 3D. FIGS. 3A to 3D are cross-sectional views of a portion of the connecting terminal 25 taken along a line A-A in FIG. 2.

Referring to FIG. 3A, the connecting terminal 25 includes a spring 25a and a terminal 25b connected to the spring 25a. As the battery module 10 is being inserted into the opening 22, and the electrode terminal 12 is being pressed against the connecting terminal 25, the terminal 25b grasps the electrode terminal 12 in the order shown in FIGS. 3B, 3C, and 3D. As shown in FIGS. 3A to 3D, in the mount frame 20 having the connecting terminal 25, merely by inserting the battery module 10 into the opening 22, electrical connection is established easily; thus, the mount frame 20 is excellent in productivity and maintenance. Although the connecting terminal 25 is shown to be formed at a portion taken along the line A-A in FIG. 2, it also is formed on the other end of the frame 21.

It is preferable that the frame 21 is made of metal or a material excellent in heat conductivity. In the case where the frame 21 is made of metal, the battery module 10 can be cooled more easily.

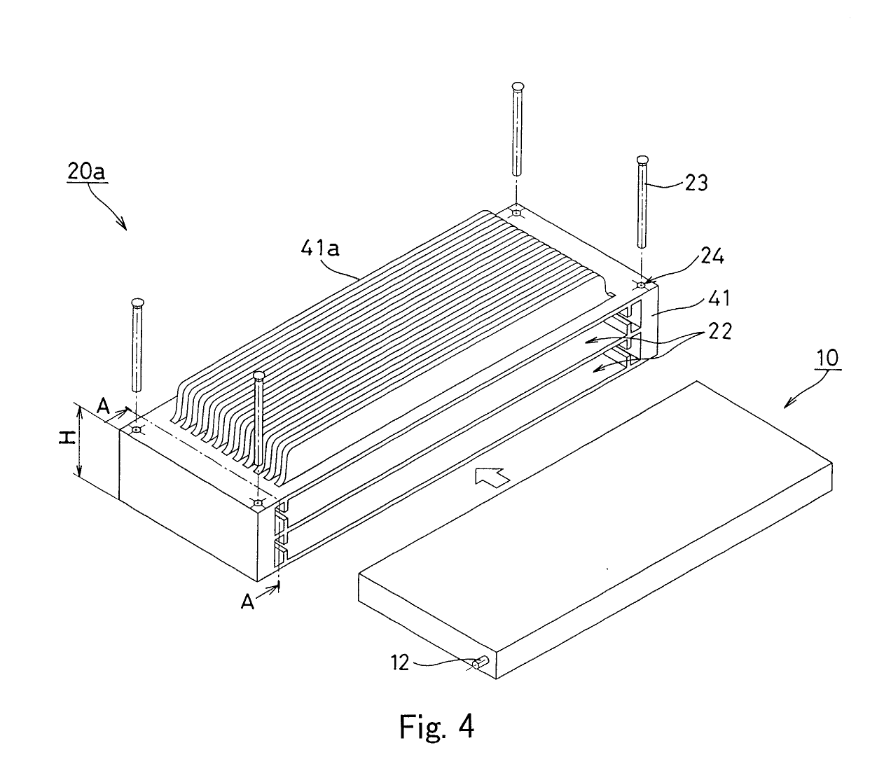

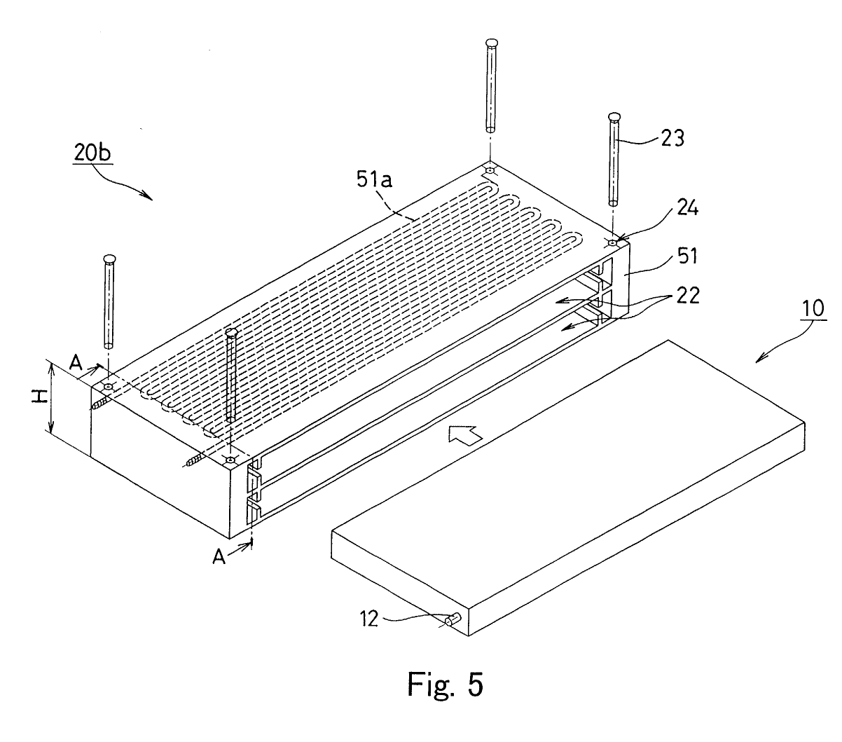

Furthermore, it is preferable that the mount frame 20 further includes a cooling member. As the cooling member, for example, a cooling fin and/or a coolant channel (path for a coolant) can be used. More specifically, it is preferable that the mount frame 20 includes at least one cooling member selected from the group consisting of a cooling fin and a coolant channel. FIG. 4 is a perspective view showing an exemplary mount frame provided with a cooling fin. Referring to FIG. 4, a mount frame 20a includes a frame 41 on which a cooling fin 41a is formed. By providing the cooling fin 41a, the mount frame 20a can be cooled naturally. If a flow of a coolant such as air is provided, a cooling effect can be enhanced further. FIG. 5 is a perspective view showing an exemplary mount frame provided with a coolant channel. Referring to FIG. 5, the mount frame 20b is provided with a frame 51 in which a coolant channel 51a is formed. The coolant channel 51a has a tubular structure for allowing a coolant such as water to flow therethrough, and the frame 51 is cooled by allowing a coolant to flow in the coolant channel 51a. The other portions of the mount frames 20a and 20b are similar to those of the mount frame 20. Therefore, a repeated description thereof is omitted here.

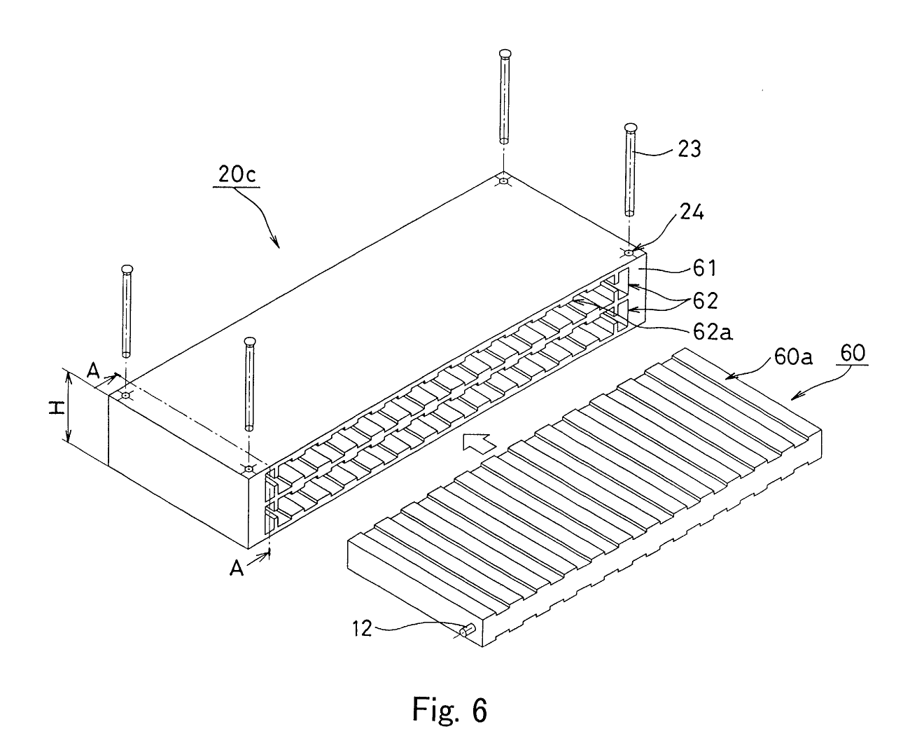

Furthermore, in the case where unevenness is formed on the surface of a battery module, it is preferable that the mount frame 20 has unevenness on an inner surface of the opening 22, for engaging with the unevenness of the battery module. FIG. 6 is a perspective view showing an exemplary battery module 60 and mount frame 20c. Referring to FIG. 6, the battery module 60 has unevenness 60a formed on both surfaces so as to enhance a heat transfer property. In the mount frame 20c, unevenness 62a engaging with the unevenness 60a of the battery module 60 is formed on an inner surface of an opening 62 of a frame 61. A contact area between the battery module 60 and the mount frame 20c is increased by using the mount frame 20c, so that a heat transfer property of the battery module 20c can be enhanced.

The mount frame of the present invention may include a connecting terminal, a cooling member, and unevenness formed on an inner surface of an opening, or these components may be combined arbitrarily.

Furthermore, in Embodiment 1, the mount frame having two openings for insertion of battery modules is shown. However, it is appreciated that the mount frame may be provided with three or more openings.

Embodiment 2

In Embodiment 2, a method for mounting battery modules of the present invention will be described.

According to the method for mounting battery modules of the present invention, the mount frame of the present invention described in Embodiment 1 is used. More specifically, a plurality of rectangular battery modules are inserted into openings of the mount frame described in Embodiment 1, and thereafter, the mount frame is disposed so that electrode plates in the battery modules are placed in a substantially horizontal or vertical direction. According to this mounting method, it is preferable that the mount frame is disposed so that the electrode plates in the battery modules are placed in a substantially horizontal direction. More specifically, it is preferable that the mount frame is disposed so that a side surface thereof having a largest area among those of the battery modules is placed in a horizontal direction.

According to the above-mentioned mounting method, by stacking mount frames on each other if required, a battery pack can be constructed easily in accordance with the shape of a space for mounting the battery pack. Furthermore, a battery pack can be constructed easily in accordance with a required output.

Thus, the present invention has been described by way of illustrative embodiments. The present invention is not limited to the above-mentioned embodiments, and is applicable to other embodiments based on the technical idea of the present invention.

As described above, the mount frame for battery modules of the present invention includes a frame provided with openings into which battery modules are inserted removably. Thus, in the mount frame of the present invention, an individual battery module can be replaced easily. Furthermore, in the mount frame of the present invention, even in the case where a difference in internal pressure is caused between the respective battery modules, the battery modules can be bound stably. Furthermore, in the mount frame of the present invention, by cooling the mount frame, the battery modules can be cooled easily. Furthermore, in the mount frame of the present invention, by changing the number of stacked battery modules, the height of a battery pack can be regulated freely. Therefore, a battery pack with high general versatility can be constructed.

Furthermore, according to the method for mounting battery modules of the present invention, the mount frame of the present invention is used, so that an individual battery module can be replaced easily, and the battery modules can be bound stably.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A mount frame for battery modules, for fixing a plurality of rectangular battery modules, comprising a frame having a plurality of openings into which the battery modules are inserted removably.

2. A mount frame for battery modules according to claim 1, further comprising a stacking member for stacking a plurality of frames on each other.

3. A mount frame for battery modules according to claim 1, wherein the frame is made of metal, and the mount frame further comprises a cooling member disposed on the frame.

4. A mount frame for battery modules according to claim 3, wherein the cooling member is at least one selected from the group consisting of a cooling fin and a coolant channel.

5. A mount frame for battery modules according to claim 1, wherein the frame has unevenness on an inner surface of each opening, which is engaged with unevenness formed on a surface of each battery module.

6. A mount frame for battery modules according to claim 1, further comprising connecting terminals that are engaged with and electrically connected to electrode terminals of the battery modules upon inserting the battery modules into the openings.

7. A method for mounting battery modules for mounting a plurality of rectangular battery modules, wherein the battery modules are inserted into the openings of the mount frame for battery modules of claim 1, and thereafter, the mount frame is disposed so that electrode plates in the battery modules are placed in a substantially horizontal or vertical direction.
